(19) United States
(12) Patent Application Publication
(10) Pub. No.: US 2009/0024661 A1
(43) Pub. Date: Jan. 22, 2009

(54) LOCATION SENSITIVE DOCUMENTS

(76) Inventor: Christopher Kelliher, Chicago, IL (US)

Correspondence Address: TELEZYGOLOGY, INC., 520 W. ERIE STREET, SUITE 210, CHICAGO, IL, 60654, US

(21) Appl. No.: 12/067,155

(22) PCT Filed: Sep. 18, 2006
(86) PCT No.: PCT/AU06/01366

§ 371 Date: Jul. 24, 2008

Related U.S. Application Data
(60) Provisional application No. 60/717,611, filed on Sep. 17, 2005.

(51) Int. Cl. G06F 17/30

(52) U.S. Cl. 707/104.1; 707/E17.044

(57) ABSTRACT

The invention relates to an electronic document created, stored in or transmitted from a geographical location, wherein the document is franked with identification of the geographical location, and optionally with time and date and/or author of the electronic document. The invention further relates to a process for franking an electronic document created, stored in, or transmitted from a geographical location, including the steps of using location determination technology means to identify the geographical location and causing the identified geographical location to be franked on the document. Additionally, the invention relates to an assembly for franking an electronic document with identification of a geographical location, the location being that of creation, storage, or transmission of the document, or any two or all of them, the assembly including means for creating, storing, or transmitting the document; location determination technology means for identifying the geographical location; and means for franking the identified geographical location on the document.

### FIELD OF THE INVENTION

This invention is concerned with the application of one or more identifying indicia to digital documents which are created electronically.

In one embodiment, the invention is concerned with digital documents which are intended to be transmitted electronically. In another embodiment, the invention is intended to enable identifying indicia to be applied through software, either in real time or retrospectively, to many types of computer files, including but not limited to: digital photographs, electronic calendars, schedulers, project, resource and time management systems, sales lead and sales force tracking systems, personal productivity applications and any software that would gain an improved facility by the addition of the identifying indicia.

The invention is intended to have particular application to such documents created on or transmitted from or to mobile electronic devices, such as mobile telephones (cell phones), portable personal computers (laptops) and wireless personal data assistants (PDAs), or in connection with software applications that generally would gain utility or be enhanced by the inclusion of location specific information.

It will be appreciated that in the foreseeable future other electronic devices may come into existence and that the invention may apply to such new devices.

### BACKGROUND OF THE INVENTION

Electronic devices which enable electronic creation and wireless transmission of documents are becoming increasingly more common. Generally, these devices sort and order in terms of time, subject, and/or author. For example, documents may be created and sent by email to or from cell phones, laptops and PDA's and similar devices, such as the Blackberry device and may then be searched or sorted on the time, subject and/or author as search or filtering criteria.

As another example, sms (short message service) documents may be created and transmitted between cell phones or between cell phones and land lines.

Electronic documents of this type may have noted on them information as to the origin of the document, namely the email address of the sender in the case of an email, or the name of the sender (if entered already in the cell phone) in the case of sms, as well as time. Some electronic documents, such as emails, have noted on them the time of receipt.

Cell phones, laptops and PDAs are commonly used by persons who are on the move, often traveling for many days or weeks at a time and often crossing many different time zones. It would be of assistance to such persons or enterprises if electronic documents were to carry more information than they do at present. For example, it would be helpful if an electronic document were to be franked with the place of creation or transmission of the document. This would allow a user an additional layer of search or sorting criteria. One example would be if a user wanted to find all photos from a certain geographic location notwithstanding date or time, a user could simply sort by the location desired. In another example it would be useful if a traveler could view where certain documents were created in relation to his itinerary. It would also be of assistance if a user could utilize a screen with past geographic location and could click through to see all documents created at a particular location. Additionally, the electronic document could also carry other indicia, such as the time and date of creation or transmission by the sender.

Also, it would be useful if the electronic scheduler, calendar or other personal productivity software application or similar contained within the device automatically recorded on a regular basis its physical location. This information would be useful in many ways, particularly in the future.

### DISCLOSURE OF THE INVENTION

Accordingly, in a first aspect, the present invention provides an electronic document created, stored in, and/or transmitted from a geographical location, wherein the document is franked with identification of the geographical location of creation, storage and/or transmission.

In a preferred embodiment, the electronic document is suitable for electronic transmission from a first geographical location to a second geographical location, and the document is franked with identification of the first geographical location. The first geographical location may be the same as the location of creation, or may be the location of storage or transmission.

The present invention also provides a process for franking an electronic document created, stored in, or transmitted from a geographical location, including the steps of using location determination technology means to identify the geographical location and causing the identified geographical location to be franked on the document.

The geographical location may be the location in which the document is created, stored or transmitted. The geographical location may be the location in which the document is stored, regardless of whether the document was created by a third party and transmitted to a device or created within the device. The geographical location may be the location from which the document is transmitted. In some cases, all or some of the locations may be the same for a specific document. In others, one or more may be different. It is within the scope of the invention that the location of any or all of creation, storage and transmission is franked on the document.

In the preferred embodiment where the document is suitable for electronic transmission from a first geographical location to a second geographical location, the process includes the steps of using location determination technology means to identify the first geographical location and causing the identified first geographical location to be franked on the document.

The invention also provides a facility or assembly for franking an electronic document or a software application with identification of a geographical location, the location being that of creation of the document or of storage of the document or of transmission of the document, or two or all of them, the facility or assembly including:
location determination technology means for identifying the geographical location; and
means for franking the identified geographical location on a document or applied to a software application.

Additionally, the document may also be franked with a certified time and/or date of creation or transmission, and/or identity of the author.

The document may be any suitable electronic document including but not limited to JPEG files, movies, MP3 files, web pages, office documents, pictures, PDF files, etc. Preferably, the document is suitable for electronic transmission and includes, without limitation, an email (with or without attachment) or an sms.

The mode of electronic transmission or communication may be chosen from a wide range of suitable modes, including but not limited to radio frequency using RFID tags, Wi-FI, AM/FM signals, a cell phone network, the internet, satellite, copper wires, fiber optics, or infrared technology. One skilled in the art will recognize that the preferred mode is wireless. Preferably, the document can be sorted or ordered based on the criteria of geographic location.

A transmitted document may be franked with a second geographical location, normally the place in which the receiver is located when the document is received.

The geographical location may be identified in any suitable way by the location determination technology means. Some of these will now be discussed by way of illustration. It is to be understood that these are not limiting on the scope of the invention.

Location may be identified, especially in the case of cell phones, by using the cell phone network. Each cell in a cell phone system covers typically about 10 square miles. Each cell has a base station with a tower, designed to communicate at low power with the cell phone. The base stations are controlled by a mobile telephone switching office, which identifies the cell a phone is in when a call is made to or from that phone. The location of the cell may be used to identify the geographical location of creation, storage or transmission for the purposes of the present invention. In this embodiment, the location determination technology means will interpret the cell location and the franking means will translate the information in a way which is compatible with the document. For example, the geographical location may appear in words or as a symbol or picture on the document itself, or the location may be attached to the document in a suitable way, so that the location may be revealed by clicking on an icon or searching a log.

In this embodiment, cell site log files, stored either in the cell phone or relayed to a server, may keep a historical running record of the locations in which the cell phone user has been. This data may be imported into appropriate software applications, by downloading the log file from the server, or by connecting the phone to a docking station, or by using wireless communication. Thus, for example, on completion of a business trip, a traveler may be able to populate a calendar for the trip with location, time and date of each activity—creation or storage of an electronic document or transmission of an electronic document.

As another example, location may be identified by using suitable mobile telephony triangulation methods.

Other methods of identifying location can include: interpretation of internet service provider's IP addresses and logon sequences; recordal of mobile data “hotspot” logins; handshake with WiFi access points, wireless LAN or routers; detection of LAN signals broadcast by a server; detection of signals transmitted by an FM or AM broadcast; triangulation of airplane transponder; and use of global positioning by satellite (GPS) receivers, which use triangulation to deduce location.

The location determination technology means may be installed in the user device itself, such as a cell phone, laptop or PDA, or it may be a separate assembly independent of the device creating the document or containing the software applications that utilize the location information. It may be carried or worn by the user for the specific purpose of collecting and storing or collecting and transmitting location, date and time information. It may be integrated into other devices such as watches, wallets, smartcards, and contactless access cards. This information could later be imported into a variety of software applications on a variety of electronic devices, either through a docking station or wirelessly to be retrospectively applied to calendar, scheduling, project management, billing, electronic mail, document creating, sales force management, time tracking, etc.

The means for creating the document and the franking means may be any suitable means, as will be apparent to one skilled in the art.

Where the electronic document is to be created on a laptop, it is preferred that the laptop includes an internal GPS receiver that can fix and track locations at specified intervals when the laptop is in stand-by mode or has incorporated into it a suitable location indicating facility. When the laptop is powered up, data as to longitude and latitude or other indicating means may be automatically stored in relevant applications—such as a calendar. Optionally, when the laptop is later connected to the internet, the data is translated to full details of the location. If desired, these may be compared with information listings of known locations to which the user of the laptop should travel, such as branch offices, suppliers, customers, etc. The information may facilitate the keeping of comprehensive records by the user of the laptop, without manual intervention.

This is one example of a device automatically recording its physical location on a regular basis. Other examples will be apparent to one skilled in the art.

### DETAILED DESCRIPTION OF THE FIGURES

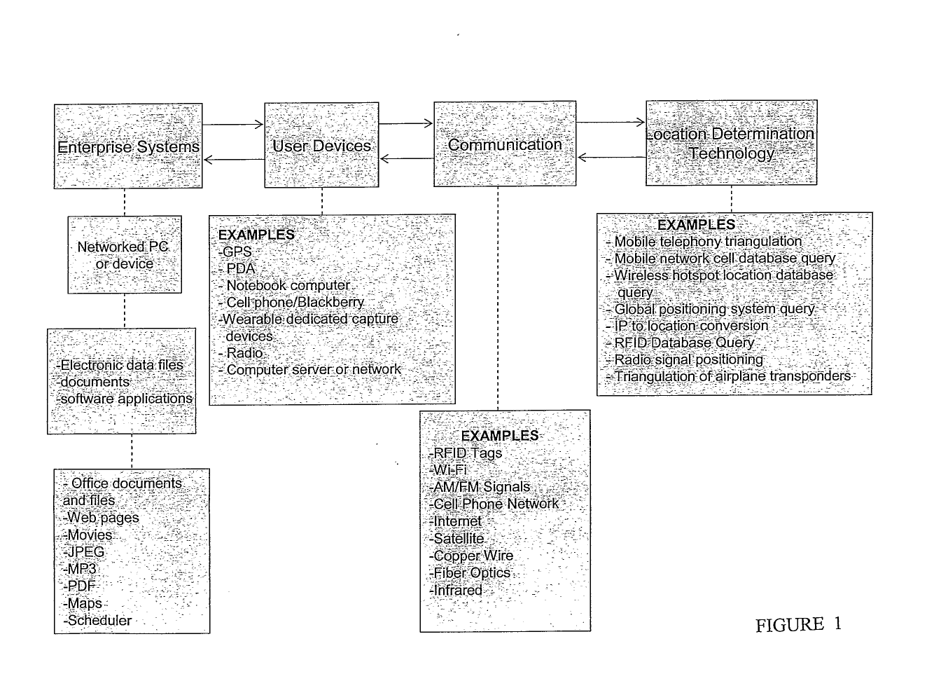

FIG. 1 is a block diagram showing an embodiment of the location input and determination path of franked documents.

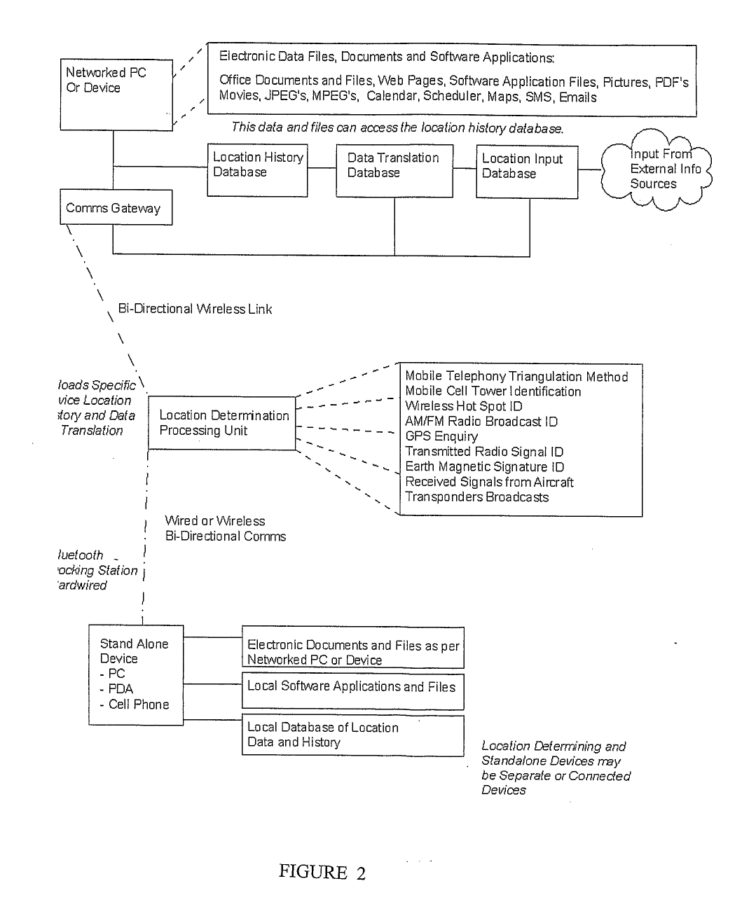

FIG. 2 is a block diagram showing a similar embodiment of the location input and determination path of franked documents.

### BEST MODES FOR CARRYING OUT THE INVENTION

This invention is best understood by following a location input and determination path, seen in FIG. 1, in order to understand how a geographical location can be franked onto a document. A document can originate from a user device. A user device may be one device or any combination thereof and may be a wide variety of sources including but not limited to PDA's, cell phones, wireless hubs, etc. From that point, the document communicates with location determination technology by any one or more of a variety of communication mediums. The user device can also communicate with enterprise systems as seen in FIG. 1. A geographical location can be readily determined by any suitable location determination technology means in the market, indicated in FIG. 1, such as identity of telephone cell; mobile telephony triangulation; mobile network cell database query; IP to location conversion; interpretation of internet service provider IP addresses and logon sequences; wireless hotspot location database query; recordal of mobile data “hotspot” logins; handshake with WiFi access points, wireless LAN or routers; detection of LAN signals broadcast by a server; RFID database query; radio signal positioning; detection of signals transmitted by an FM or AM broadcast; triangulation of airplane transponders; and global positioning by satellite receiver. Other future suitable means are also anticipated to be used in carrying out the prevent invention and are within its scope.

Once a geographical location is identified, the identification of the location can be franked on a document, at the time when the document is created, stored, or transmitted, by any suitable means known by the persons skilled in the art. The document can be created as a word file, email, sms, or any suitable files by computers, PDA's, mobile phones, etc.

Software suitable to enable the invention to be carried out can be created in a manner readily apparent to one skilled in the art.

The path outlined in FIG. 1 is a two-way path. The location determination technology means can communicate with the user device and vice versa.

Once proper communication has occurred, a user can sort, search, filter, order, etc. by way of geographic location in addition to time, subject, and/or author.

In FIG. 2, a location determination processing unit identifies geographical location, when a digital document is created, stored, or transmitted, by using any suitable means in the market, such as mobile telephony triangulation method; mobile cell tower identification; wireless hot spot ID; AM/FM radio broadcast ID; GPS enquiry, transmitted radio signal ID; earth magnetic signature ID; received signals from aircraft; and transponders broadcasts. The location determination processing unit then uses a bi-directional wire or wireless link to transmit the information of the geographical location to a networked PC or device which is adapted to access and maintain a database of location history.

A standalone device, such as PC, PDA, or cell phone, adapted to create, store, and/or transmit digital documents receives from the location determination processing unit the information of the geographical location and frank on the document that information, showing where the document is created, stored or transmitted. The location determination processing unit and the standalone device may be separate or connected devices.

Throughout the specification and claims the word “comprise” and its derivatives, if used, are intended to have an inclusive rather than exclusive meaning unless the context requires otherwise.

### INDUSTRIAL APPLICABILITY

As will be readily appreciated by those skilled in the various arts, the invention disclosed herein is not limited to the examples set out and has wide application in many areas. The invention represents a significant advance in the art of identifying the geographical location of a document, particularly franking the document with identification of the geographical location.

1. An electronic document created, stored in, and/or transmitted from a geographical location, wherein the document is franked with identification of the geographical location of creation, storage and/or transmission.

2. The document of claim 1, wherein the geographical location is the location in which the document is created and/or stored, or the location from which the document is transmitted.

3. The document of claim 1 or 2, which is franked with time and date of the electronic transmission, creation, or storage of the document, or with identity of the author of the document.

4. The document of any one of claims 1 to 3, wherein the document is an email or sms.

5. The document of any one of claims 1 to 4, wherein the document is adapted for wireless transmission.

6. The document of any one of claims 1 to 5, wherein the document is adapted for sorting or ordering based on the criteria of geographic location.

7. A process for franking an electronic document created, stored in, or transmitted from a geographical location, including the steps of using location determination technology means to identify the geographical location and causing the identified geographical location to be franked on the document.

8. The process of claim 8, wherein the geographical location is the location in which the document is created, stored or transmitted.

9. The process of claim 7 or 8, wherein the location determination technology means uses any one or more of:
identity of telephone cell;
mobile telephony triangulation;
interpretation of internet service provider IP addresses and logon sequences;
recordal of mobile data “hotspot” logins;
handshake with WiFi access points, wireless LAN or routers;
detection of LAN signals broadcast by a server;
detection of signals transmitted by an FM or AM broadcast;
triangulation of airplane transponder; and
global positioning by satellite receiver.

10. An assembly for franking an electronic document with identification of a geographical location, the location being that of creation, storage, or transmission of the document, or any two or all of them, the assembly including:
location determination technology means for identifying the geographical location; and
means for franking the identified geographical location on the document.

11. An electronic document substantially as herein described with reference to FIG. 1 or FIG. 2 of the accompanying drawings.

12. A process for franking on electronic document substantially as herein described with reference to FIG. 1 or FIG. 2 of the accompanying drawings.

13. An assembly for franking on electronic document substantially as herein described with reference to FIG. 1 or FIG. 2 of the accompanying drawings.
